(19) United States
(12) Patent Application Publication
(10) Pub. No.: US 2025/0187819 A1
(43) Pub. Date: Jun. 12, 2025

(54) TRANSPORT CONTAINER WITH A PROTECTIVE DEVICE FOR TRANSPORTATION OF A TRANSPORT ITEM

(71) Applicant: ANDREAS STIHL AG & Co. KG, Waiblingen (DE)

(72) Inventor: Jeffrey BAY, Kirchheim unter Teck (DE)

(73) Assignee: ANDREAS STIHL AG & Co. KG, Waiblingen (DE)

(21) Appl. No.: 18/977,021

(22) Filed: Dec. 11, 2024

(30) Foreign Application Priority Data
Dec. 11, 2023 (DE) 10 2023 134 555.9

(51) Int. Cl. B65D 88/74

(52) U.S. Cl. CPC B65D 88/74

(57) ABSTRACT

A transport container with an interior for receiving a transport item includes a container wall with at least one container opening for supplying the interior with air of an environment; and at least one protective device for shielding the at least one container opening against a medium of the environment, which is in particular liquid, liquid droplet-shaped, liquid particle-containing and/or crystal-shaped The at least one protective device has an air inlet area for modifying an air flow of the air to the at least one container opening. The air inlet area extends in a circumferential direction around the at least one container opening and is configured to discharge the medium along the circumferential direction.

### CROSS-REFERENCE TO RELATED APPLICATIONS

This application claims priority under 35 U.S.C. § 119 to German patent application DE 102023134555.9, filed Dec. 11, 2023, the entire disclosure of which is incorporated herein by reference.

### BACKGROUND OF THE DISCLOSURE

1. Field of the Disclosure The present disclosure is in the field of transportation technology and relates to a transport container with an interior for receiving a transported item.

### 2. DESCRIPTION OF RELATED ART

Transport containers to transport a transport item are used in a wide variety of forms and configurations. One of the main tasks of the transport container is to protect the transport item from harmful external influences. Depending on the type of the transport item, another task of the transport container is to ensure safety, especially if the transport items are electrical components and devices.

For example, special equipment must be provided on and in the transport container for transporting electrical chargers and accumulators, primarily to ensure that the interior is supplied with air from an environment. However, it must always be ensured that, for example, no harmful liquid media in the form of water droplets, spray or splash water gets into the transport container.

Various approaches are known from the prior art patent literature.

For example, Japanese patent document No. JP 2012-81879 A relates to a transport structure with a charger chamber for receiving a charger and with a battery receiving chamber for receiving a battery. The transport structure is mounted on the side of a frame of a refuse collection vehicle. In order to cool both the charger and the battery depending on an ambient temperature, the transport structure has an inlet opening for introducing outside air into the charger chamber and an outlet opening in the battery receiving chamber for discharging the air. A cooling fan is arranged inside the transport structure and is used to draw in air from the environment via the inlet opening. To prevent the penetration of moisture in the form of water droplets, a cover plate is arranged at each of the openings, which forms an opening directed towards the floor. To protect the charger from rainwater or washing water, a movable partition wall is formed inside the charger chamber behind the inlet opening and in front of the charger.

For further known prior art, reference is made to the publications EP 4 037 136 A1, CN 217983476 U, CN 218274933 U, DE 199 29 899 A1 and US 2004/0108150 A1.

### SUMMARY OF THE DISCLOSURE

It is an object of the present disclosure to provide a transport container with an interior for receiving a transport item, in which a ventilation of the interior is realized and, when the ventilation is ensured, protection against harmful media of the environment is improved.

The object is achieved by the features of independent claim 1. Further embodiments and applications of the present disclosure result from the dependent claims and are explained in more detail in the following description with partial reference to the figures.

To supply the interior with air from an environment, the transport container comprises at least one container opening. In order to shield the at least one container opening from harmful media of the environment, the transport container comprises at least one protective device, which is arranged at the at least one container opening. The at least one protective device is primarily configured above ensure an effective protection of the interior in any location of the transport container and thus in any position and/or in any orientation, while simultaneously ventilating the interior. The transport container according to the present disclosure is primarily configured for a transport item in the form of at least one electrical component.

According to a first general aspect, the present disclosure relates to a transport container with an interior for receiving a transport item, comprising a container wall with at least one container opening for supplying the interior with air of an environment; at least one protective device for shielding the at least one container opening against a medium of the environment, which is in particular liquid, liquid droplet-shaped, liquid particle-containing and/or crystal-shaped; wherein the at least one protective device comprises an air inlet area for modifying an air flow of the air to the at least one container opening, wherein the air inlet area extends in a circumferential direction around the at least one container opening and is configured to substantially discharge the medium along the circumferential direction.

The medium can be a medium that is harmful to the transport item. For example, if the transport item is an electrical component in the form of a charger and/or an accumulator, the interior of the transport container must basically be protected against water as a harmful medium. For example, the at least one protective device initially offers a basic protection against a medium in the form of splash water and rainwater (in each case droplet-shaped water) as well as snow (water in a more or less crystalline state).

The present disclosure makes it possible to provide a transport container with a ventilation function, which, in different locations, i.e., positions and/or orientations, always provides adequate protection against the penetration of a harmful medium into the interior. With the transport container according to the present disclosure, it is possible to discharge the medium around the at least one container opening and thus over an angular range of 360 degrees. The transport container can thus be arranged in an exposed location and still provide effective protection against the penetration of the medium into the interior from different directions.

According to a further aspect of the present disclosure, it can be provided that the air inlet area is configured to substantially separate the medium, in particular the liquid droplet-shaped and/or liquid particle-containing medium, from the air flow and in particular to guide the separated medium along the at least one protective device in a defined direction.

This allows a transport container with a separation function to be provided, which also forms an effective protection against the medium in the event of a generated and/or formed and/or occurring air flow for ventilating the interior, in which the medium is essentially separated in and/or at the air inlet area and then discharged. The medium can be, for example, water in droplet form and/or in atomized form (e.g. spray, spray mist). Additionally or alternatively, the medium can be a dispersion medium, in particular in the form of a suspension as a heterogeneous mixture of substances with undissolved solid particles in a liquid medium (e.g. water with coarse solid particles).

The air flow can be actively generated by a fan in the interior of the transport container and/or at least result from this in order to realize a ventilation for a transport item, for example, in the form of at least one electrical component. Simultaneous penetration of a (sucked in) medium in the air flow can be essentially prevented.

Additionally or alternatively, the air flow can be generated passively in relation to the transport container if, for example, the transport container is mounted on a loading platform of a flatbed truck in an exposed location and a mixture of air flow and medium flows around the flatbed truck and thus the transport container as a result of a movement of the flatbed truck.

It is possible that the air inlet area is formed completely circumferential; and/or that the air inlet area comprises at least one inlet opening and/or forms at least one inlet opening with the container wall, wherein the at least one inlet opening is formed slot-shaped or slit-shaped, in particular with a substantially constant slot width or with a substantially constant slit width.

A slot-shaped or slit-shaped form of the air inlet area can further improve, for example, the separation function.

According to a further aspect of the present disclosure, it can be provided that the air inlet area is formed in the form of a labyrinth, which extends in the circumferential direction around the at least one container opening, in particular extends completely circumferentially, in order to guide the air flow in sections at least once substantially parallel to the container wall and/or in sections at least once substantially perpendicular to the container wall.

The form of the air inlet area in the form of a labyrinth with at least one deflection of the air flow can also improve the separation function for harmful media, so that penetration into the interior is essentially prevented.

It is possible that the air inlet area comprises at least one first edge and at least one second edge for deflecting the air flow, which are spaced apart from one another and/or opposite to one another and/or formed offset from one another, wherein in particular the at least one first edge and/or the at least one second edge is each formed as an edge at which a respective edge angle is substantially equal to or less than 110 degrees.

The edge angle can be a resulting and/or a measurable edge angle. The at least one first edge and/or the at least one second edge can, in each case, be formed by two adjacent and/or delimitable surfaces, which are in each case formed in particular substantially flat. Alternatively, it is possible for the at least one first edge and/or the at least one second edge to be formed by two adjacent curved surfaces.

According to a further aspect of the present disclosure, it can be provided that the at least one first edge and the at least one second edge are spaced apart relative to one another and arranged in different locations relative to one another, in order to form a Z-shaped deflection of the air flow in a cross-sectional view.

In other words, the at least one first edge and the at least one second edge can be arranged and/or formed in relation to one another so that, in a cross-sectional view, a resulting direction of flow of the air flow is Z-shaped. This can, for example, further optimize the separation of harmful medium from the air flow.

It is possible that the air inlet area is formed in the form of a nozzle in sections in a flow direction of the air flow in order to accelerate the air flow to the at least one container opening and/or to decelerate the air flow to the at least one container opening.

A nozzle-shaped form can comprise an enlargement of a resulting flow cross-section and/or a reduction of a resulting flow cross-section along a flow direction.

According to a further aspect of the present disclosure, it can be provided that the air inlet area comprises a discharge section for the medium which partially adjoins the container wall and/or which is partially arranged opposite to the container wall in order to drain the medium substantially in a defined direction.

It is possible that the discharge section is formed as a circumferential edge, a circumferential groove, a circumferential shoulder, a circumferential channel and/or a circumferential duct, and/or comprises at least one of these.

In particular, the discharge section extends around the at least one container opening.

According to a further aspect of the present disclosure, it can be provided that the at least one protective device is formed ring-shaped in sections or ring disk-shaped in sections for mounting on the container wall, each with a through opening, wherein in particular in a flow direction of the air flow the through opening is flush with the at least one container opening or merges into the at least one container opening via at least one shoulder, in particular via at least one circumferential shoulder.

This makes it possible, for example, to realize a comparatively low height of the at least one protective device on the outside of the container wall.

It is possible that the at least one protective device is formed essentially symmetrically to at least one plane.

The at least one protective device can be formed to be essentially mirror-symmetrical to at least one center plane. The at least one center plane can be a defined or definable center plane.

According to a further aspect of the present disclosure, it can be provided that the at least one protective device is formed in one piece, in particular integrally in one piece, with a frame part and with a shielding part, or in at least in two pieces with a frame element and with a shielding element, wherein the frame element and the shielding element are each formed as separate individual elements, wherein, in particular in an assembled state, the shielding part or the shielding element each extends at a distance from the container wall at least over the frame part or over the frame element.

The assembled state can be a state in which the at least one protective device is mounted on the transport container in order to fulfill a proper and/or intended function.

According to a further aspect of the present disclosure, it can be provided that the at least one container opening is characterized by a cross-section, and that the frame part or the frame element each comprises a through an opening which is formed substantially identical or at least similar to the cross-section of the at least one container opening.

The at least one container opening can be characterized by an essentially circular or oval cross-section.

It is possible that the frame part or the frame element, and/or that the shielding part or the shielding element is formed essentially flat in sections and/or essentially plate-shaped in sections; and/or that the shielding part or the shielding element for limiting the air inlet area is formed essentially flat and shell-shaped, or essentially flat and tub-shaped.

This allows a transport container to be provided, which is characterized by at least one protective device with a comparatively low overall height.

According to a further aspect of the present disclosure, it can be provided that the frame part or the frame element each comprises a circumferential discharge section for the medium, and that at least one cover strip is arranged and/or formed on the shielding part or on the shielding element each in a circumferential direction, wherein, in particular in the assembled state, the at least one cover strip is arranged opposite and/or at a distance from one side of the discharge section.

The at least one cover strip can be manufactured by at least one flanging process. The at least one cover strip can be arranged and/or formed to discharge the medium and/or to separate the medium.

It is possible that the frame part and the shielding part, or that the frame element and the shielding element each together form at least two flow-through ducts for the air flow, which are arranged in the circumferential direction around the through opening and open into the through opening.

According to a further aspect of the present disclosure, it can be provided that the transport item comprises at least one electrical component and/or is formed as at least one such component, wherein in particular the transport item comprises a charger and/or at least one accumulator.

### BRIEF DESCRIPTION OF THE DRAWINGS

The embodiments and features of the present disclosure described above can be combined with each other in any manner. Further or other details and advantageous effects of the present disclosure are explained in more detail below with reference to the accompanying figures.

FIG. 1 shows a section (sectional view) of a first embodiment of the transport container according to the present disclosure.

FIG. 2 shows a further section (partial sectional view) of the first embodiment of the transport container according to the present disclosure.

FIG. 3A shows a perspective view of a frame element of the protective device of the first embodiment of the transport container according to the present disclosure;

FIG. 3B shows the frame element from FIG. 3A in a front view;

FIG. 4A shows a shielding element of the protective device of the first embodiment of the transport container according to the present disclosure in a first perspective view;

FIG. 4B shows the shielding element from FIG. 4A in a second perspective view;

FIG. 5 shows the section of the transport container from FIG. 1, whereby the flow machine arranged in the interior of the transport container at the at least one container opening is hidden;

FIG. 6 shows the section of the transport container from FIG. 2, whereby the flow machine arranged in the interior of the transport container at the at least one container opening is hidden;

FIG. 7 shows a perspective view of the transport container according to the first embodiment.

### DETAILED DESCRIPTION OF THE DISCLOSURE

The present disclosure is not limited to the described embodiment. Rather, a large number of variants and modifications are possible which also make use of the inventive concept of the present disclosure and therefore fall within the scope of protection. In particular, the present disclosure also claims protection for the subject matter and the features of the subclaims independently of the claims referred to.

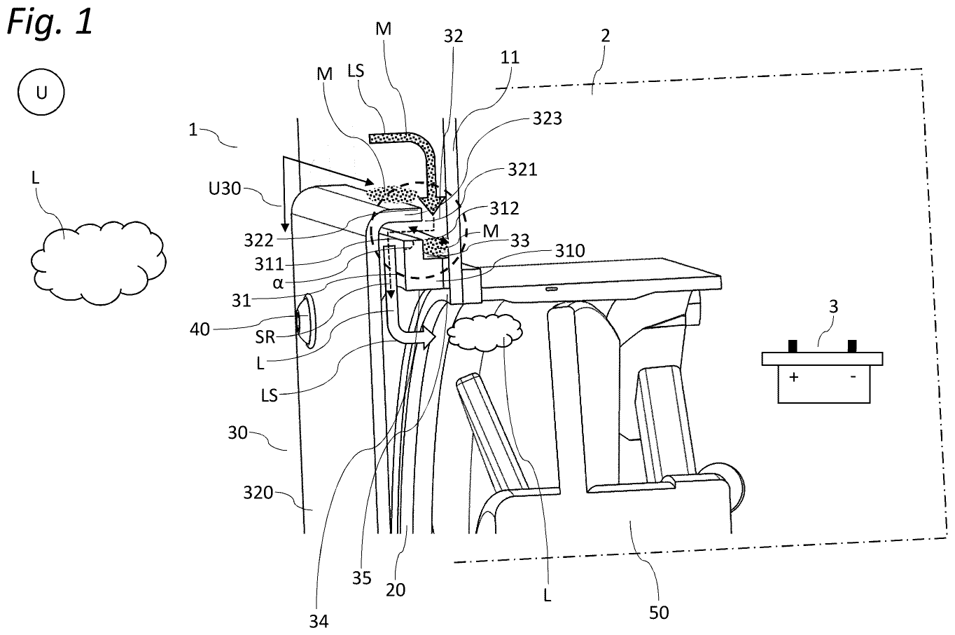

FIG. 1 shows a section (sectional view) of a first embodiment of the transport container 1 according to the present disclosure.

The transport container 1 is used for transporting a transport item 3 and for this purpose comprises an interior 2 for receiving the transport item 3. The transport container 1 is configured primarily for transporting a transport item 3 in the form of at least one electrical component, the transportation of which is associated with special requirements. The at least one electrical component can be, for example, an electrical charger and/or an accumulator and/or an arrangement of several accumulators. In the case of a transport item 3 in the form of at least one electrical component, requirements relating to safety and thermal management in particular must be met. This includes, for example, ensuring sufficient ventilation and thus an adequate supply of air L from an environment U to the interior 2.

To ensure ventilation, the interior 2 must be protected from harmful media M of the environment U, such as water in various forms, coarse particles, dirt, dust, etc. However, in order to be able to ventilate the interior 2, at least one opening on the transport container 1 is necessary so that an exchange of air L with the environment U is possible.

The transport container 1 comprises a container wall 11 with at least one container opening 20 for supplying the interior 2 with air L from the environment U. The container wall 11 is a component of the transport container 1, which comprises several container walls 11 in order, for example, to determine the size and form of the interior 2.

The transport container 1 can comprise a container wall 11 in the form of a removable or pivotably mounted lid, by means of which the transport container 1 can be opened and/or closed. The transport container 1 can be configured for mounting on a frame of a vehicle, for example a commercial vehicle. The transport container 1 can be configured for mounting on a loading platform or underneath a loading platform of a flatbed truck. The transport container 1 can be formed, for example, cuboidal, although alternative configurations are possible. In other words, the transport container 1 can be formed as a transport crate or a transport box. The container wall 11 and further container walls 11 of the transport container 1 can be made of a material based on a plastic, a metal or a metal alloy. The container wall 11 and further container walls 11 of the transport container 1 are each formed in particular substantially flat and/or substantially plate-shaped and are therefore characterized by a substantially flat outer surface on the outside of the transport container 1 with respect to the environment U.

The at least one container opening 20 can comprise a substantially circular cross-section. It is possible that the at least one container opening 20 is characterized by a different cross-section, for example by an oval cross-section or by a rectangular cross-section. In particular, the cross-section is each a closed cross-section.

In order to protect the at least one container opening 20 and, in particular, the interior 2 from a medium M with a harmful effect on the transport item 3, and nevertheless to ensure a supply of air L to the interior 2 via the at least one container opening 20, the transport container 1 comprises at least one protective device 30 for shielding the at least one container opening 20 from a medium M of the environment U, which is liquid droplet-shaped, liquid particle-containing and/or crystalline.

The at least one protective device 30 comprises an air inlet area 31 for modifying an air flow LS of the air L to the at least one container opening 20. The air inlet area 31 extends in a circumferential direction U30 around the at least one container opening 20. In other words, the air inlet area 31 is an inlet area for air L extending around the at least one container opening 20. The air inlet area 31 is configured to discharge the medium M, in particular in the form of splash water and/or rainwater, along the circumferential direction U30, in particular in a defined and/or predetermined direction. As a result, a basic protection of the interior 2 against harmful media M for the transport item 3 can be realized.

If the transport container 1 is sprayed with a medium M in the form of spray water, it can be discharged and thus diverted away from the at least one container opening 20.

To discharge the medium M in a defined direction, the air inlet area 31 comprises a discharge section 33 (see the double arrow drawn in the area of the discharge section 33), which partially adjoins the container wall 11 and/or which is partially arranged opposite to the container wall 11. The discharge section 33 is defined, inter alia, by the edge 312 in the form of a discharge edge, which is formed by a shoulder with two mutually adjacent surfaces. The adjacent surfaces are essentially flat and are not marked in the figures for reasons of clarity.

The discharge section 33 can be formed as a substantially square circumferential discharge section. Alternatively, it is possible for the discharge section 33 to be formed as a substantially circular or oval circumferential discharge section. The discharge section 33 can be formed as a circumferential edge, a circumferential groove, a circumferential shoulder, a circumferential channel and/or a circumferential duct, and/or comprise at least one of these. This can improve the discharge of a medium M, in particular in the form of splash water and/or rainwater, and thus essentially prevent it from entering the at least one container opening 20.

In the present embodiment of the transport container 1, the discharge section 33 is arranged and/or formed on a frame element 310. The frame element 310 is a component of the at least one protective device 30, which in this embodiment is formed in at least two pieces and thus in several pieces and comprises a shielding element 320 in addition to the frame element 310. Both the frame element 310 and the shielding element 320 are each formed and/or manufactured as a separate individual part. It is possible that, in an alternative embodiment of the transport container 1, the at least one protective device 30 is formed in one piece and thus integrally in one piece and comprises a section as a frame part and a section as a shielding part.

The frame element 310 and the shielding element 320 are described in more detail with reference to further figures. As can be seen from the illustration in FIG. 1, the shielding element 320 is substantially flat in sections and/or substantially plate-shaped in sections and thus comprises a substantially flat outer surface to the environment U and a substantially flat inner surface to the at least one container opening 20. In addition, the shielding element 320 comprises at least one cover strip 323, 324, 325, 326, of which the cover strip 323 is visible in FIG. 1.

The inner surface of the shielding element 320 together with the at least one cover strip 323, 324, 325, 326, i.e., with respective inner surfaces, as well as the frame element 310 contribute to the formation of the flow path and thus the flow direction SR of the air flow LS.

The transport container 1 can be configured at least according to the so-called IPX4 standard (International Protection Code), i.e., according to the IPX protection class IPX4 and/or at least based on it, whereby at least a protection against a medium M in the form of splash water from all directions (splash water on all sides) is provided.

The at least one protective device 30 is basically configured to discharge the medium M along the circumferential direction U30 and thus over an angular range of 360 degrees in the event of a missing or non-existent air flow LS. This makes it possible, for example, to mount the transport container 1 in different locations, i.e., in different positions and/or in different orientations.

The separation function can be realized by and/or by means of an occurring air flow LS. The air flow LS can be actively generated by a flow machine 50 of the transport container 1, for example in the form of a fan with at least one impeller, within the interior 2 of the transport container 1, which in an operating state, draws in air L from the environment U via the at least one container opening 20 and thus generates an air flow LS at and/or in the air inlet area 31. It is understood that the transport container 1 can comprise at least one further container opening 20 in order to remove air L already contained in the interior 2 from the interior 2 and thus realize a ventilation. At least one further protective device 30 can be arranged at the at least one further container opening 20 as disclosed herein.

Alternatively, it is possible that the flow machine 50, which is arranged in the interior 2 at the at least one container opening 20, is operated in such a way that the air L located in the interior 2 is drawn in, compressed and blown out via the at least one container opening 20 and the at least one protective device 30. In other words, air L can also be drained from the interior 2 into the environment U via the at least one protective device 30 and thus via the air inlet area 31.

It is additionally or alternatively possible for the air flow LS to be generated passively, for example by a moving vehicle on which the transport container 1 is mounted in an exposed location and around which air L from the environment U flows.

The air inlet area 31 is further configured to essentially separate the medium M, in particular the liquid, liquid droplet-shaped and/or liquid particle-containing medium M, from the air flow LS and in particular to guide the separated medium M along the at least one protective device 30 in a defined direction.

On the one hand, the at least one protective device 30 is configured primarily to discharge splash water, spray and snow. In addition, the penetration of media M in the form of dispersion media, in particular in the form of suspensions as heterogeneous mixtures of substances with undissolved solid particles in a liquid medium, can be essentially prevented or at least significantly and/or negligibly reduced as a result of separation at the at least one protective device 30.

The air inlet area 31 is formed completely circumferential. The air inlet area 31 comprises at least one inlet opening 32 and/or forms at least one inlet opening 32 with the container wall 11. The at least one inlet opening 32 can be formed slot-shaped and thus formed as a slot, or slit-shaped and thus formed as a slit, in particular with a substantially constant slot width or with a substantially constant slit width. The at least one inlet opening 32 can, for example, be configured in accordance with the IEC 60335-1 standard and/or at least be based thereon. A slot width or a slit width can, for example, be in a range between 3.2 mm and 6.4 mm.

The air inlet area 31 can be formed in the form of a labyrinth, which extends in the circumferential direction U30 and around the at least one container opening 20, in order to guide the air flow LS in sections at least once essentially parallel to the container wall 11 and/or in sections at least once essentially perpendicular to the container wall 11. In this way, for example, a deflection of the air flow LS with an associated change in the flow direction SR is realized, by means of which the function of the separation can be improved.

The air inlet area 31 comprises at least one first edge 321 and at least one second edge 311 for manipulating the air flow LS in the form of a deflection, each of which is formed by two adjacent surfaces. The at least one first edge 321 is associated with the shielding element 320 and/or formed on the shielding element 320, that is, on the at least one cover strip 323, and the at least one second edge 311 is associated with the frame element 310 and/or formed on the frame element 310.

The at least one first edge 321 and the at least one second edge 311 are spaced apart and offset from one another, in particular in the flow direction SR of the air flow LS, and are arranged in different locations and thus different orientations relative to each other in order to provide a defined flow path and thus a defined flow direction SR for the air flow LS. As can be seen from the sectional view in FIG. 1, the at least one first edge 321 and the at least one second edge 311 form a (resulting) Z-shaped deflection of the air flow LS in a cross-sectional view.

Due to the air flow LS, medium M contained in the air flow LS is essentially separated and discharged at least at the at least one first edge 321, so that in the further course of the flow direction SR essentially only the air flow LS is guided to the at least one container opening 20. With corresponding flow ratios and/or forms of the at least one first edge 321 and the at least one second edge 311, the at least one second edge 311 can also contribute to the separation of a medium M from the air flow LS. The at least one first edge 321 is thus a separating edge for the medium M. In addition, the at least one second edge 311 can be a separating edge.

Both the at least one first edge 321 and the at least one second edge 311 can each be characterized by an edge angle α that is less than or equal to approximately 110 degrees. In the illustrated embodiment example of the transport container 1 in FIG. 1, the resulting edge angle α is essentially approximately 90 degrees.

It should be noted that the discharge section 33 forms more or less an area of rest and/or a circulation area for the air flow LS in terms of flow, in which a resulting flow velocity of the air flow LS is comparatively low, at least in the flow direction SR.

In order to further improve the separation effect or the separation function, the air inlet area 31 can be formed in the flow direction SR of the air flow LS to be nozzle-shaped in sections in order to accelerate the air flow LS to the at least one container opening 20 and/or to decelerate the air flow LS to the at least one container opening 20. In other words, a resulting flow cross-section of the air inlet area 31 for the air flow LS can increase and/or decrease, in order to improve respective flow effects and an associated separation function for separating a medium M from the air flow LS.

As can also be seen from the illustration in FIG. 1, the cover strip 323 (and the further cover strips 324, 325 and 326) further comprises the outer edge 322, which is arranged opposite to the at least one first edge 321 as a separating edge. The outer edge 322 contributes to the outer contour of the shielding element 320 as a limiting edge of the shielding element 320.

The frame element 310 is characterized by the through opening 34, which merges into the at least one container opening 20 via a shoulder 35. The cross-section of the through opening 34 can be essentially identical to the cross-section of the at least one container opening 20 and therefore essentially circular in the present embodiment.

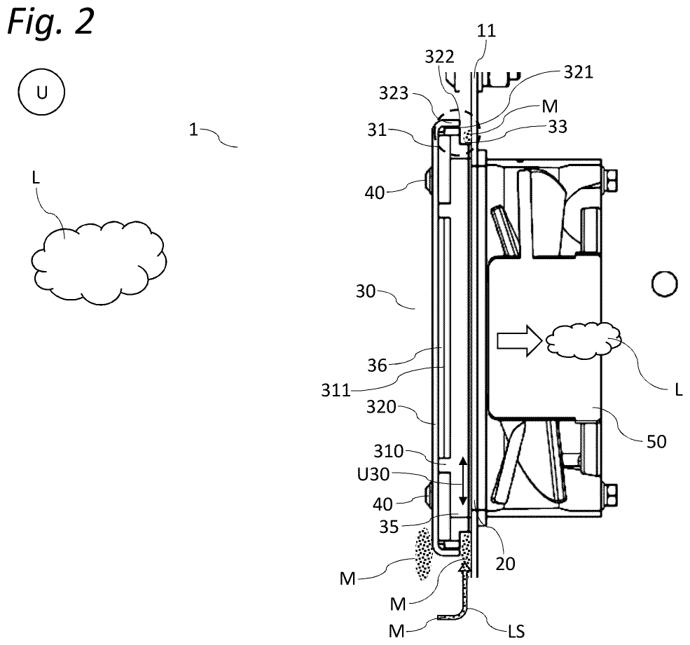

FIG. 2 shows a further section (partial sectional view) of the first embodiment of the transport container 1 according to the present disclosure.

The frame element 310 is formed for immediate (direct) mounting on the container wall 11. The shielding element 320 is formed for immediate (direct) mounting to the frame element 320. The at least one protective device 30 can, for example, be fastened to the container wall 11 by means of at least one screw connection 40 with at least one screw. Alternatively, other types of connection, for example essentially form-fit and/or essentially force-fit connections in the form of snap-in connections or plug-in connections, are conceivable for fastening the at least one protective device 30 to the container wall 11.

FIG. 2 shows a flow-through duct 36 of four flow-through ducts 36, 37, 38, 39 for the air flow LS of the at least one protective device 30, which is arranged in the circumferential direction U30 around the through opening 34 and opens into the through opening 34. The flow-through duct 36 is formed in the flow direction SR in particular after the corresponding at least one second edge 311 by the frame element 310 and the shielding element 320.

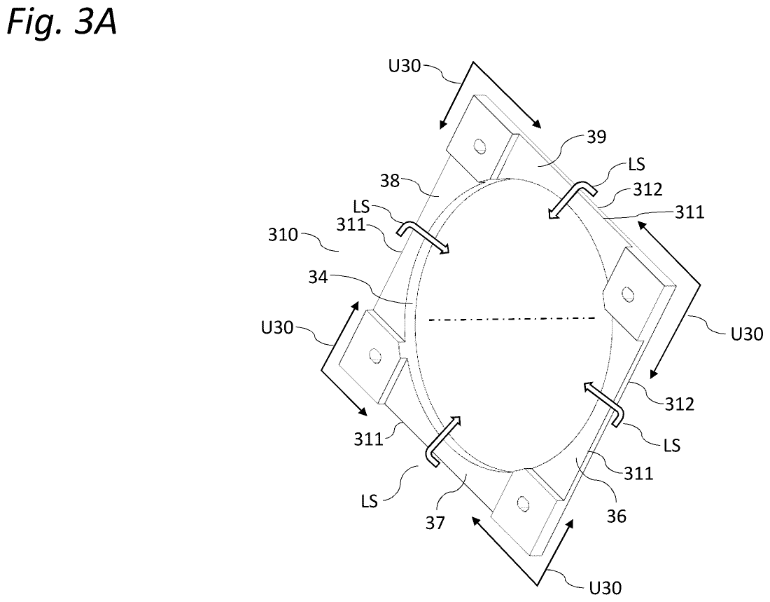

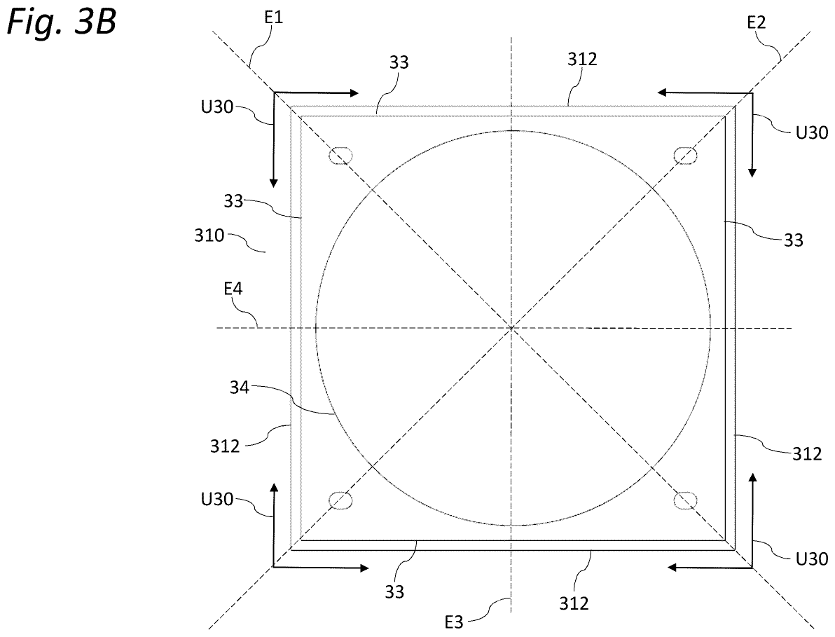

FIG. 3A shows a first perspective view of the frame element 310 of the at least one protective device 30 of the first embodiment of the transport container 1 as a support structure for the shielding element 320. FIG. 3B shows a front view (main view) of the frame element 310 of FIG. 3A.

The frame element 310 is formed ring-shaped in sections or ring disk-shaped in sections, each with a through opening 34. Overall, the frame element 310 is essentially flat and is used to support the shielding element 320 and for connection, i.e., mounting, to the container wall 11.

The reference signs 36, 37, 38, 39 indicate surfaces of the frame element 310 in the embodiment which, together with the shielding element 320, i.e., with the inner surface of the shielding element 320 in an assembled state, form a respective flow-through duct 36, 37, 38, 39 for the air flow LS towards the through opening 34.

FIG. 3A clearly shows the at least one second edge 311, which extends in sections in the circumferential direction U30.

The frame element 310 comprises four mounting bases with through-holes for the shielding element 320, which are arranged in the circumferential direction U30. The mounting bases are not labelled in more detail for reasons of clarity.

It can be seen from the illustration in FIG. 3B and from the combined view of FIGS. 3A and 3B, the frame element 310— apart from the formation and/or arrangement of through-holes for screw connections 40— is formed substantially mirror-symmetrically to at least one plane E1, E2, E3, E4, in particular to four planes E1, E2, E3, E4.

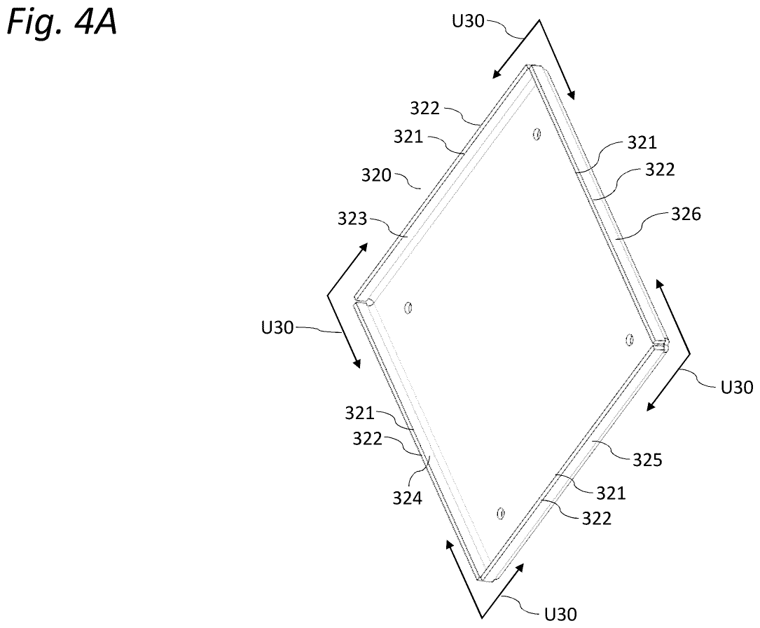

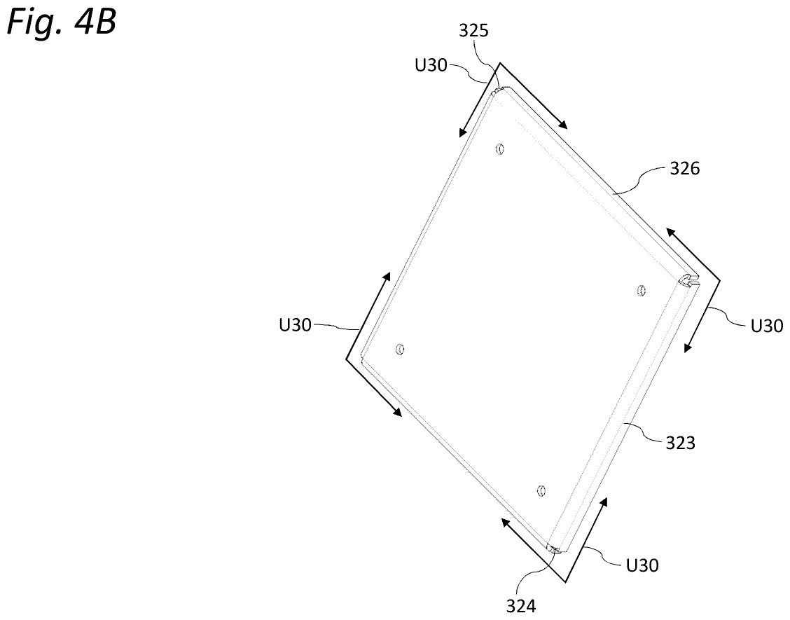

FIG. 4A shows the shielding element 320 of the at least one protective device 30 of the first embodiment of the transport container 1 in a first perspective view, and FIG. 4B shows the shielding element 320 of FIG. 4A in a second perspective view.

In FIG. 4A, the inner surface is recognizable as a substantially flat surface of the shielding element 320, which in the assembled state is directed towards the at least one container opening 20 and/or is at least partially opposite thereto. In FIG. 4B, the essentially flat outer surface of the shielding element 320 is again recognizable. Furthermore, the cover strips 324, 324, 325, 326 extending in the circumferential direction U30 are recognizable, which can be manufactured, for example, by a respective flanging process.

The shielding element 320 is formed substantially flat and shell-shaped, or substantially flat and tub-shaped, to limit the air inlet area 31.

The shielding element 320 and/or the frame element 310, or the at least one protective device 30 as an individual part can be manufactured, for example, by at least one injection molding process, by at least one casting process, by at least one sintering process and/or by at least one 3D printing process.

It is also possible to integrate at least one filter element in the air inlet area 31, for example to provide an extended protection against a medium M in the form of dust.

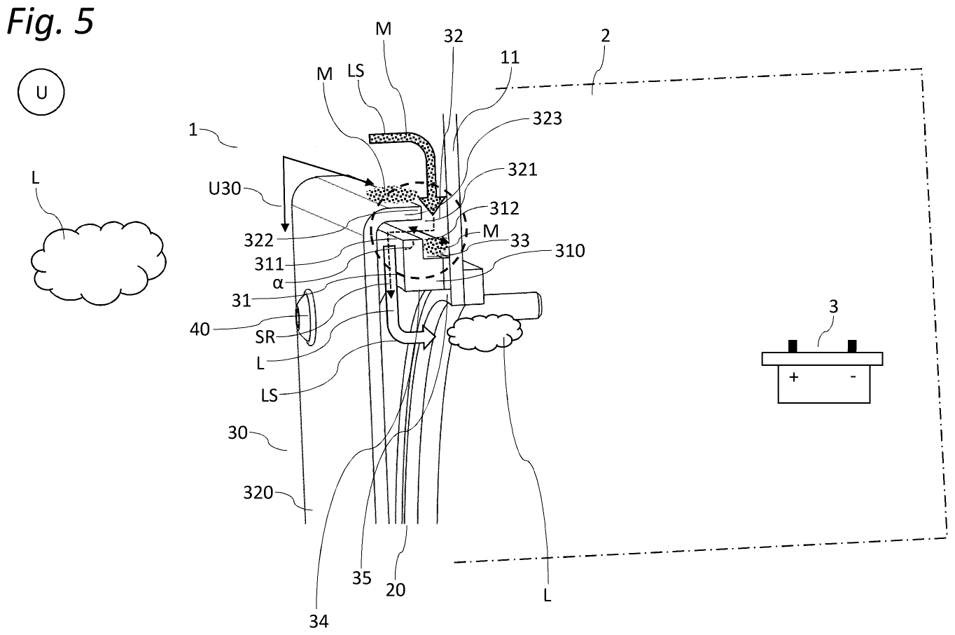

FIG. 5 shows the section of the transport container 1 from FIG. 1, whereby the flow machine 50 arranged in the interior 2 of the transport container 1 at the at least one container opening 20 is hidden.

The transport container 1 can be configured differently with regard to the flow machine 50 and/or its arrangement in the interior 2. In the first embodiment of the transport container 1, the flow machine 50 can be arranged at the at least one container opening 20, as shown in FIG. 1. Alternatively, an arrangement of the flow machine 50 in the interior 2 is possible, for example, according to which the flow machine 50 is spaced apart from the at least one container opening 20.

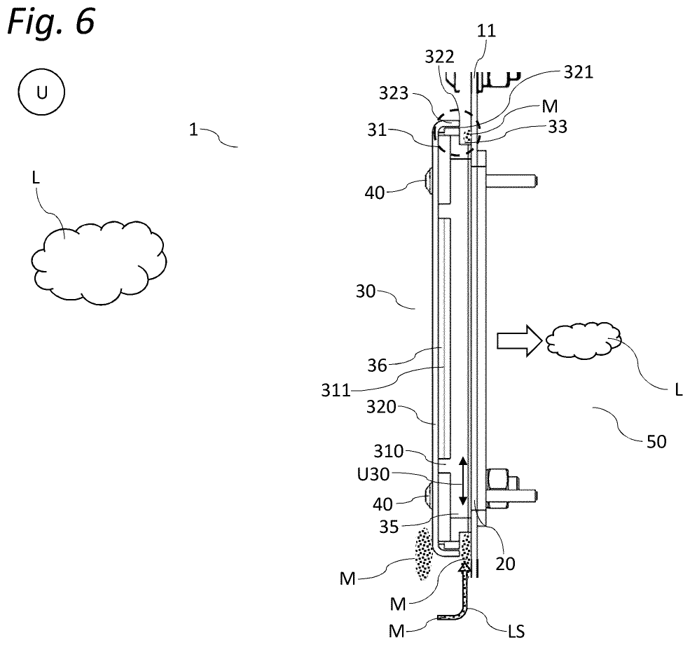

FIG. 6 shows the section from FIG. 2, whereby the flow machine 50 arranged in the interior 2 of the transport container 1 at the at least one container opening 20 is hidden.

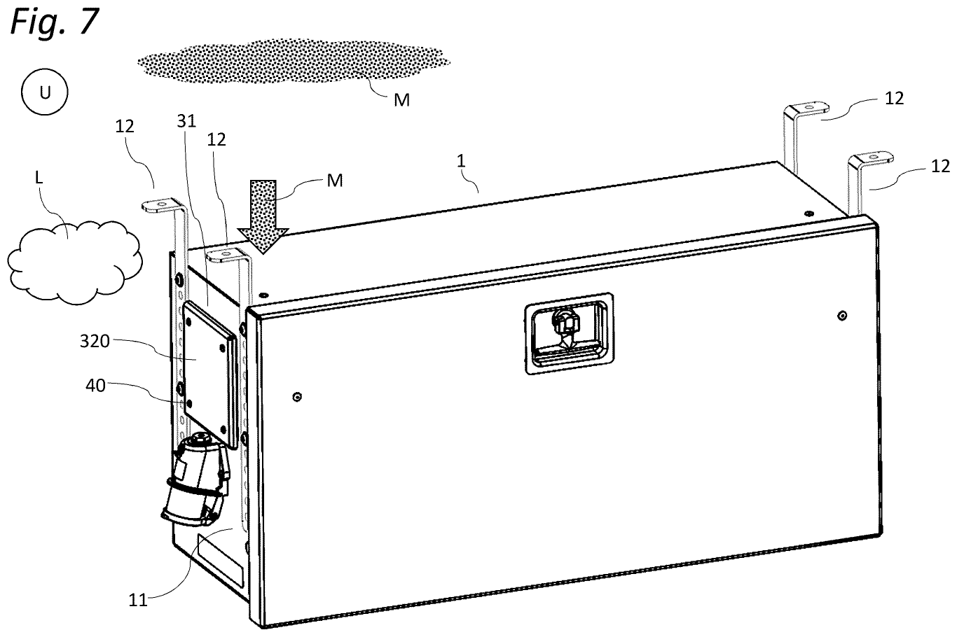

FIG. 6 shows once again that the at least one protective device 30 is characterized by a comparatively low overall height, so that the outside of the container wall 11 does not have any significant influence on the dimensions of the transport container 1, which can also be seen, for example, from the illustration in FIG. 7.

FIG. 7 shows the transport container 1 according to the first embodiment in a perspective view.

The transport container 1 is configured primarily for receiving and/or transporting electrical components as transport item 3. The electrical components can primarily be chargers and/or accumulators and/or other electrical devices of corresponding dimensions. The transport container 1 is essentially cuboid in shape and can be closed by means of a container wall in the form of a lid, for example by means of at least one screw connection and/or by means of at least one snap-in connection.

As can be seen from the illustration in FIG. 7, the transport container 1 can be configured for mounting on a frame of a commercial vehicle and for this purpose comprise, for example, four mounting strips 12. The mounting strips 12 can each be attached to two spaced-apart container walls 11 opposite to one another and each comprise an angled mounting section for attaching the transport container 1 to the frame.

With the present disclosure, a transport container 1 can be provided which primarily ensures splash water protection regardless of the location of the transport container 1. The transport container 1 can thus also be used in particularly exposed locations, such as on a loading platform of a flatbed truck, and still provide an effective protection of the transport item 3 against harmful media M.

The present disclosure is not limited to the embodiment described above. Rather, a large number of variants and modifications are possible which also make use of the inventive concept and therefore fall within the scope of protection. In particular, the present disclosure also claims protection for the subject matter and features of the subclaims independently of the referenced claims.

### LIST OF REFERENCE SYMBOLS

1 transport container
2 interior
3 transport item
11 container wall
12 mounting strip
20 container opening
30 protective device
31 air inlet area
32 inlet opening
33 discharge section
34 through opening
35 shoulder
36 flow-through duct
37 flow-through duct
38 flow-through duct
39 flow-through duct
40 screw connection
50 flow machine
310 frame element
311 edge
312 edge
320 shielding element
321 edge
322 edge
323 cover strip
324 cover strip
325 cover strip
326 cover strip
E1 plane
E2 plane
E3 plane
E4 plane
L air
LS airflow
M Medium
SR flow direction
U environment
U30 circumferential direction
α edge angle

What is claimed is:

1. A transport container with an interior for receiving a transport item, comprising:
a container wall with at least one container opening for supplying the interior with air from an environment;
at least one protective device for shielding the at least one container opening against a medium of the environment;
wherein the at least one protective device comprises an air inlet area for modifying an air flow of the air to the at least one container opening,
wherein the air inlet area extends in a circumferential direction around the at least one container opening and is configured to discharge the medium along the circumferential direction.

2. The transport container according to claim 1,
wherein the air inlet area is configured to separate the medium from the air flow and to guide the separated medium along the at least one protective device in a defined direction.

3. The transport container according to claim 1,
wherein the air inlet area is formed completely circumferential; or
wherein the air inlet area comprises and/or forms at least one inlet opening with the container wall, wherein the at least one inlet opening is formed slot-shaped or slit-shaped.

4. The transport container according to claim 1,
wherein the air inlet area is formed in the form of a labyrinth, which extends in the circumferential direction around the at least one container opening, in order to guide the air flow in sections at least once parallel to the container wall and/or in sections at least once perpendicular to the container wall.

5. The transport container according to claim 1,
wherein the air inlet area comprises at least one first edge and at least one second edge for deflecting the air flow, which are spaced apart from one another and/or opposite to one another and/or formed offset from one another.

6. The transport container according to claim 5,
wherein the at least one first edge and/or the at least one second edge is each formed as an edge in which a respective edge angle is equal to or less than 110 degrees.

7. The transport container according to claim 5,
wherein the at least one first edge and the at least one second edge are spaced apart relative to one another and arranged in different locations relative to one another, in order to form a Z-shaped deflection of the air flow in a cross-sectional view.

8. The transport container according to claim 1,
wherein the air inlet area is formed in the form of a nozzle in sections in a flow direction of the air flow in order to accelerate the air flow to the at least one container opening and/or in order to decelerate the air flow to the at least one container opening.

9. The transport container according to claim 1,
wherein the air inlet area comprises a discharge section for the medium, which partially adjoins the container wall and/or which is partially arranged opposite to the container wall in order to drain the medium in a defined direction.

10. The transport container according to claim 9,
wherein the discharge section is formed as a circumferential edge, a circumferential groove, a circumferential shoulder, a circumferential channel, and/or as a circumferential duct, and/or comprises at least one of these.

11. The transport container according to claim 1,
wherein the at least one protective device is formed ring-shaped in sections or ring disk-shaped in sections for mounting on the container wall, each with a through opening.

12. The transport container according to claim 11,
wherein in a flow direction of the air flow the through opening is flush with the at least one container opening or merges into the at least one container opening via a shoulder.

13. The transport container according to claim 1,
wherein the at least one protective device is formed symmetrically to at least one plane.

14. The transport container according to claim 1,
wherein the at least one protective device is formed in one piece with a frame part and with a shielding part, or in at least two pieces with a frame element and with a shielding element, wherein the frame element and the shielding element are each formed as separate individual elements,
wherein the shielding part or the shielding element each extends at a distance from the container wall at least over the frame part or over the frame element.

15. The transport container according to claim 14,
wherein the at least one container opening has a cross-section, and
wherein the frame part or the frame element each comprises a through opening which is formed identical or at least similar to the cross-section of the at least one container opening.

16. The transport container according to claim 14,
wherein the frame part or the frame element, and/or wherein the shielding part or the shielding element each is formed flat in sections and/or plate-shaped in sections; and/or
wherein the shielding part or the shielding element for limiting the air inlet area is formed flat and shell-shaped, or flat and tub-shaped.

17. The transport container according to claim 14,
wherein the frame part or the frame element each comprises a circumferential discharge section for the medium, and
wherein at least one cover strip is arranged and/or formed on the shielding part or on the shielding element each in a circumferential direction,
wherein the at least one cover strip is arranged opposite and/or at a distance from one side of the discharge section.

18. The transport container according to claim 14,
wherein the frame part and the shielding part, or wherein the frame element and the shielding element each together form at least two flow-through ducts for the air flow, which are arranged in the circumferential direction around the through opening and open into the through opening.

19. The transport container according to claim 1,
wherein the transport item comprises at least one electrical component and/or is formed as at least one such component.
